(19) United States
(12) Patent Application Publication
(10) Pub. No.: US 2026/0046289 A1
(43) Pub. Date: Feb. 12, 2026

(54) SYSTEMS AND METHODS FOR MONITORING THE SOCIAL MEDIA USAGE OF STUDENTS

(71) Applicants: Shekinah Ingram, West Point, VA (US); Sheloir Johnson, West Point, VA (US)

(72) Inventors: Shekinah Ingram, West Point, VA (US); Sheloir Johnson, West Point, VA (US)

(21) Appl. No.: 18/903,407

(22) Filed: Oct. 1, 2024

Related U.S. Application Data
(60) Provisional application No. 63/681,171, filed on Aug. 9, 2024.

(51) Int. Cl. H04L 9/40

(52) U.S. Cl. CPC H04L 63/102; H04L 63/08

(57) ABSTRACT

A system for monitoring and managing the access of a user to social media accounts is disclosed, including at least one user computing device in operable connection with a user network. An application server is in operable communication with the user network to host an application program for monitoring and managing a user's access to social media outlets. The application program is designed to prohibit student access to social media during school, or during other non-permitted times, or while the student is at a non-permitted location. The application includes a user module for identifying a user's and assigning a user credential to each user. A monitoring module monitors the activity of each users and reports their activity to an administrative user. An alert module transmits an alert to the administrative user upon each user's access to a non-permitted application.

### CROSS-REFERENCE TO RELATED APPLICATIONS

The present application claims priority to U.S. Provisional Application No. 63/681,171 filed Aug. 9, 2024, titled “Peace in School (PIS),” which is hereby incorporated by reference in its entirety.

### TECHNICAL FIELD

The embodiments disclosed herein generally relate to systems and methods monitoring the usage of social media application, and more specifically relates to an application for selectively prohibiting access to social media applications while the user is in a defined location during pre-determined time periods.

### BACKGROUND

Advances in technology have made the use of smart devices ubiquitous in modern cultures. In such, many have become reliant on these devices for communication with others. While smart devices have certainly had a major impact on the quality of life for many individuals, their use can become distracting, especially for children. In particular, children can become distracted while at school which can inhibit their ability to learn and has a negative impact on their in-person social interactions.

The rise of social media has compounded these distractions, as children often access these platforms during school hours, diverting their attention from educational activities. Some states have taken on the legislative challenge of removing access to potential social media account holders who are under a certain age (in many cases thirteen years old) except for if and when they have parental support during their social media use. It may be beneficial, and perhaps more reasonable, to restrict children's access to social media during school. For example, it may be most efficient to restrict access to social media in schools who already have existing phone usage policies (e.g., no cellphone use in classrooms), rather than approaching social media companies with the idea of restricting access to underage users on the platform itself.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to system for monitoring and managing the access of a user to social media accounts, including at least one user computing device in operable connection with a user network. An application server is in operable communication with the user network to host an application program for monitoring and managing a user's access to social media outlets. The application program is designed to prohibit student access to social media during school, or during other non-permitted times, or while the student is at a non-permitted location. The application includes a user module for identifying a user's and assigning a user credential to each user. A monitoring module monitors the activity of each users and reports their activity to an administrative user. An alert module transmits an alert to the administrative user upon each user's access to a non-permitted application.

The system and methods disclosed herein provide a means of monitoring user access to non-permitted application (e.g., social media applications, social media websites, etc.) such that the users are incentivized or deterred from accessing non-permitted material. This is especially useful during school, while studying, or in other environments wherein such applications and other media can inhibit social, education, or other development.

The application program is capable of identifying users who have accessed any non-permitted application while at a pre-specified location and/or during non-permitted time periods. For example, the application program may monitor student access to non-permitted application while on school property, while in a classroom, and/or their access during specific period of time (such as during school hours, study hours, etc).

The system enables the identification of administrative users (which may include school personnel, tutors, parents, and/or guardians) to enable the transmission of alerts to the administrative users which alert them of non-permitted access to any social media application website, etc.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of an exemplary computer system infrastructure, according to some embodiments;

FIG. 2 illustrates a block diagram of the application program and modules, according to some embodiments;

FIG. 3 illustrates a block diagram of the system infrastructure, according to some embodiments;

FIG. 4 illustrates a schematic of an environment wherein the system is operable to monitor and manage user access to non-permitting application, according to some embodiments;

FIG. 5 illustrates a screenshot of the social media application listing interface, according to some embodiments;

FIG. 6 illustrates a screenshot of the administrative interface having a student listing, according to some embodiments; and

FIG. 7 illustrates a screenshot of the notification and alerts interface having the student listing to identify students who have accessed non-permitted applications;

FIG. 8 illustrates a flowchart of a method for monitoring student access to non-permitted applications, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to systems and methods for monitoring, controlling, and/or prohibiting the usage of social media application and/or websites during prohibited time periods and/or while at specified locations. The system enables an administrative user to monitor usage of a student computing device (e.g., a cellphone) to enable the administrative user to determine if the student has accessed a social media application or website. The embodiments are useful for restricting a student's access to social media while attending school, during school hours, during study hours, during homework hours, and/or during other times when it may be beneficial for the student to be focused on learning.

The system may transmit a notification of probable social media usage to authorized school administration personnel, teachers, etc. following the students access to social media during pre-determined hours and/or at a specific location (e.g., while on school property, while within a classroom, etc.).

In some embodiments, the students may be notified by the application if they were deemed to have accessed social media. In such, the student remains aware that administration is monitoring their access to social media.

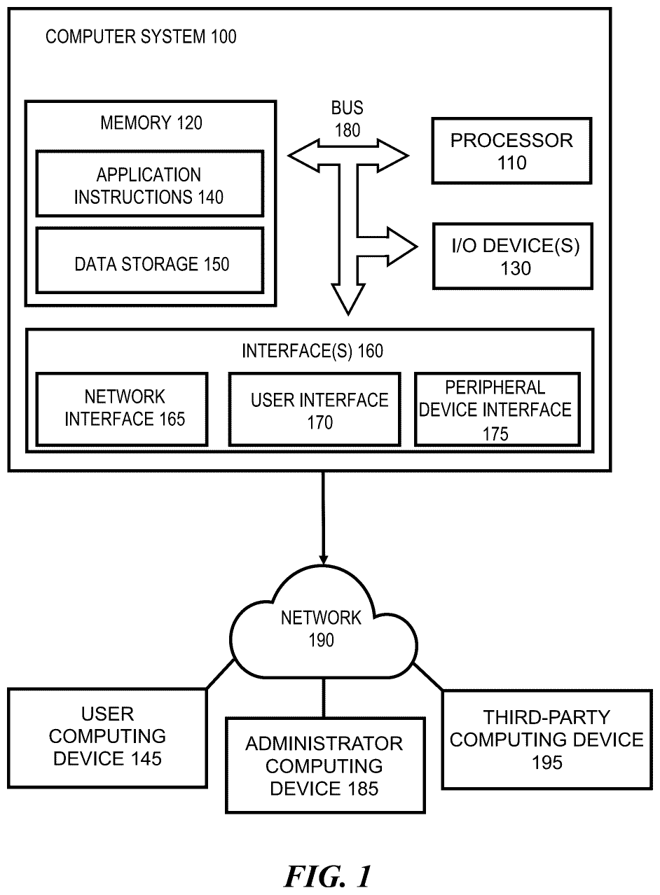

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 140, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C #, JAVA, JAVASCRIPT, PERL, etc.).

In this disclosure, terms “store,” “storage,” “data store,” “data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

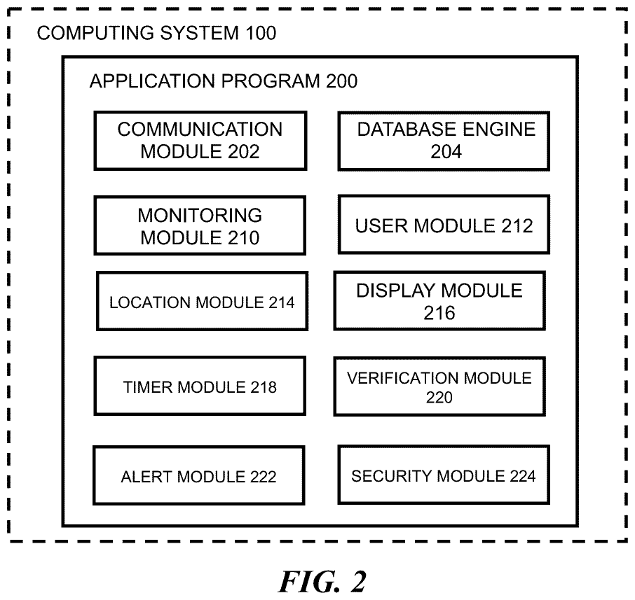

FIG. 2 illustrates an example computer architecture for the application program 200 operated via the computing system 100. The computing system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a monitoring module 210, a user module 212, a location modelling module 214, a display module 216, a timer module 218, a verification module 220, an alert module 222, and a security module 224.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195.

In some embodiments, the communication module 202 is operable to transmit an alert or notification, via the alert module 222 to the administrative user and/or third-part user to indicate if the student has accessed a non-permitted application.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

In some embodiments, the monitoring module 210 determines if the student user has accessed a non-permitted application. The monitoring module 210 may be in communication with the location module 214 and/or timer module 218 to determine if the student user has accessed the non-permitted application within a non-permitted region and/or during a time period which is not permitted.

In some embodiments, the user module 212 facilitates the creation of a user account for the application system. The user module 212 may allow the user to create a user profile which includes user information, user preferences, and user-associated information. The user module may also be used to assign a user type to each user. The user module may enable the user to establish preferences which may include the region wherein the student user's access is not permitted, a time period during which access to the non-permitted application is not permitted, user credentials and identity, etc. The user module applies to an administrative user and or a student.

In some embodiments, the location modelling module 214 is in operable communication with the application program 200 to determine if the user is in a non-permitted location (e.g., on school property, in a classroom, etc.). The location module may also determine that the student user is off school property and therefor permit the user to access otherwise non-permitted applications.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored.

In some embodiments the timer module 218 may determine if the user is accessing non-permitted applications during non-permitted time frames. For example, the timer module 218 may determine if the user is accessing the non-permitted application during school hours, study hours, etc.

In some embodiments, the verification module 220 verifies the user's identity to determine if the user is an administrative user, parent or guardian, or student user.

In some embodiments, the alert module 222 receives an alert signal from the location module 214, timer module 218, and/or monitoring module 210 to determine if the student user has accessed the non-permitted application.

In some embodiments, the security module 224 is operable to authenticate each user upon their registration and/or login to the application program 200. The security module 224 may prompt the user to authenticate themselves using a dual-factor authentication process, or similar security protocol. In some embodiments, the security module 224 may be in operable communication with the verification module 220 to verify the user's identity upon the user logging into the application program 200.

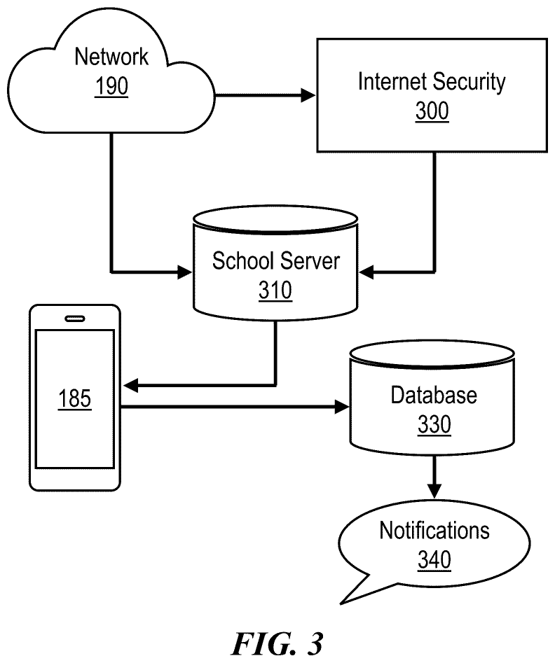

FIG. 3 illustrates a block diagram of the system infrastructure. The network 190 is in operable communication with the internet security 300 and school server 310. The device 185 and database 330 are in communication with the school server 310. A notification 340 is transmitted if the user device 185 has accessed a non-permitted application program.

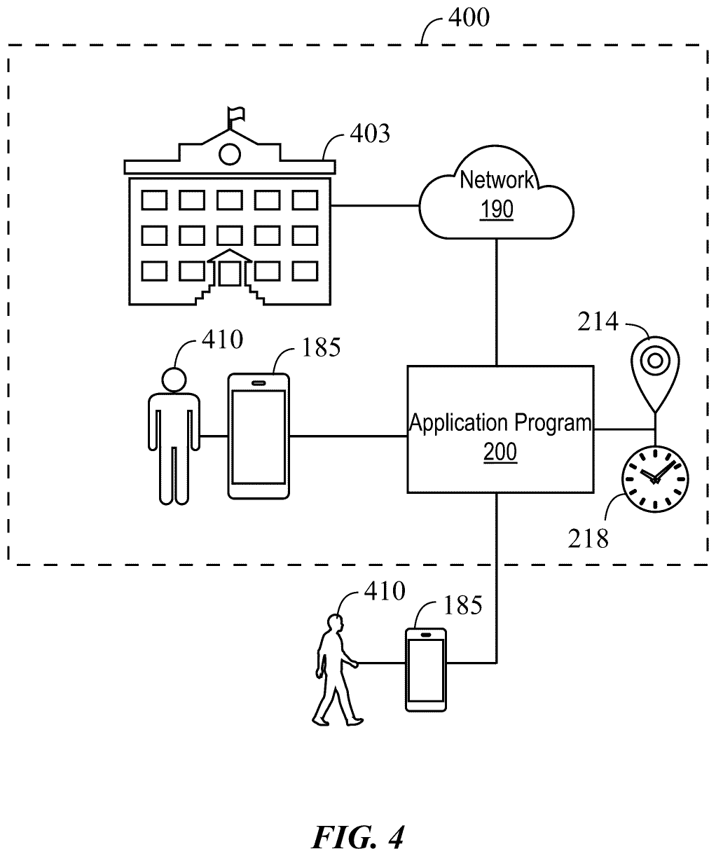

FIG. 4 illustrates a schematic of an environment wherein the system is operable to monitor and manage user access to non-permitting application. The location 400 is pre-defined by administrative users and may include a school 403 or other location in which users 410 are prohibited from accessing the non-permitted application via their device 185. The application program 200, timer module 218 and location module 214 determine if the user 410 are within the location 400. Users 410 and devices 185 who are outside of the location 400 may be permitted to access any application on their device without triggering an alert or other notification to the school 340, administrative user, parent, or guardian.

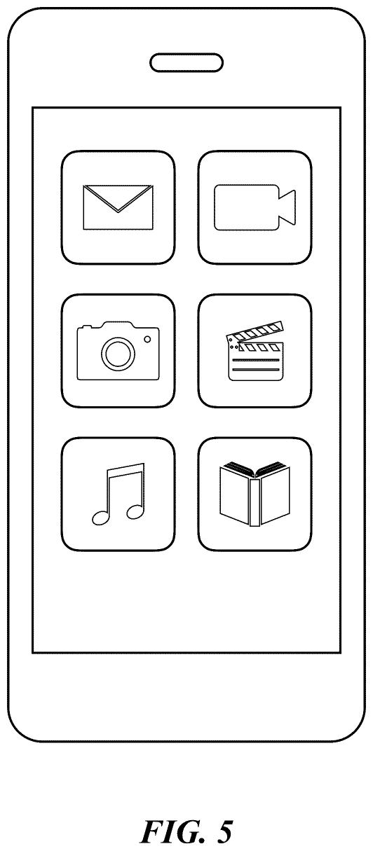

FIG. 5 illustrates a screenshot of the social media application listing interface which includes a plurality of application which may or not be permitted. For example, any application which is characterized as a social media application or similar application which may cause distraction within a learning environment may be prohibited. The application program described by the embodiments presented herein is capable of monitoring the access of the student to any non-permitted applications.

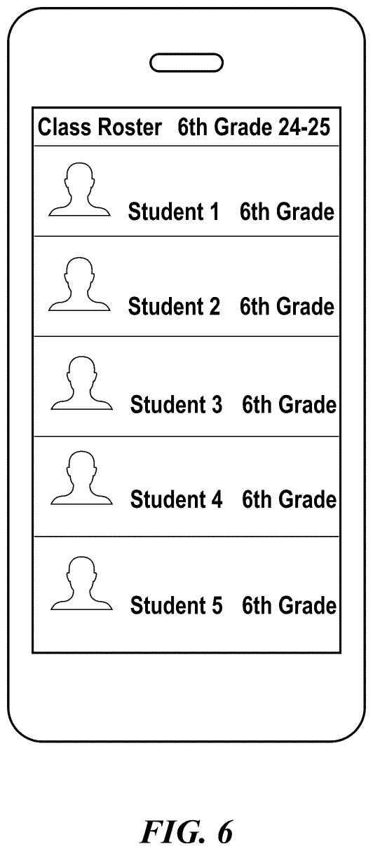

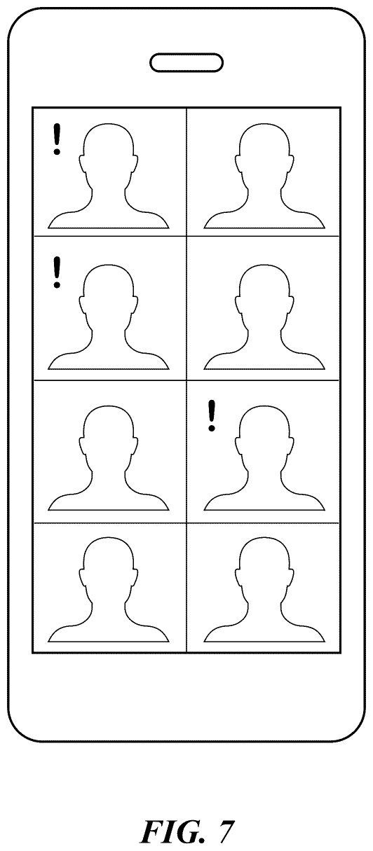

FIG. 6 illustrates a screenshot of the administrative interface having a student listing wherein a plurality of student users are displayed. Along with FIG. 7, this enables administrative users to view a listing of students and view if/when students have accessed a non-permitted application.

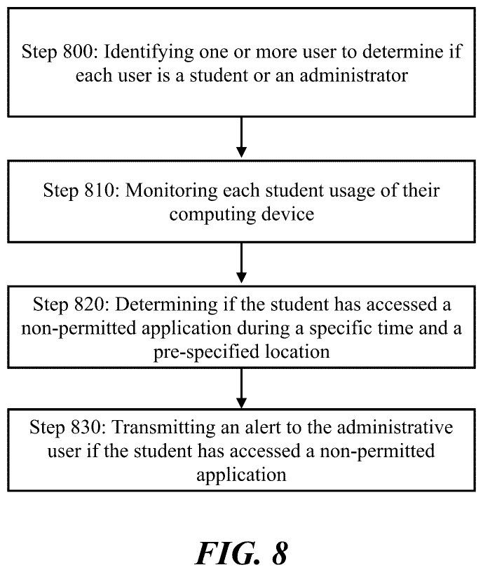

FIG. 8 illustrates a flowchart of a method for monitoring student access to non-permitted applications. In step 800, one or more users are identified, and their identification and user credentials are verified, via the verification module, to determine if the user is a student user, and administrative user, or a parent/guardian. In step 810, students'usage of their computing device is monitored, via the monitoring module and the system determines if the student has accessed a non-permitted application in step 820. In step 830, an alert or notification is transmitted via the alert module to an administrative user, student user and/or parent or guardian if the non-permitted application was accessed.

In this disclosure, the various embodiments are described with reference to the flowchart illustrations and/or block diagrams of methods, apparatus (systems), and computer program products.

Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

1-20. (canceled)

21. A system for monitoring and managing the access of a student to social media applications in a school comprising:
a plurality of student mobile phones owned and controlled by students, the student mobile phones being in operable connection with a school computer network;
a plurality of administrator electronic devices, the administrator electronic devices being in operable connection with the school computer network;
an application server in operable communication with the school computer network, the application server comprising a non-transitory computer-readable recording medium storing an application program for monitoring and managing access by the students to social media applications accessible on the student mobile phones, which application program, when executed by a processor, causes the non-transitory computer-readable recording medium to perform steps comprising:
storing a list of the social media applications not permitted to be accessed by the students at a school location during school hours;
storing a list of the students registered to use the application program on the application server;
assigning a student user credential to each of the students that are registered to use the application program;
storing a list of school administrators registered to use the application program on the application server;
assigning an administrator user credential to each of the school administrators that are registered to use the application program;
blocking access to only the social media applications on the student mobile phones when the student mobile phones are in operable connection with the school computer network on school grounds during school hours without affecting other functions of the student mobile phones including calling, texting, web browsing, and accessing email;
monitoring and temporarily storing the activity of the students on the student mobile phones when the student mobile phones are in operable connection with the school computer network on school grounds during school hours; and
periodically reviewing the activity and, upon detecting an attempt by at least one of the students to access at least one of the social medial applications or a web page hosting a social media account when the student mobile phones are in operable connection with the school computer network on school grounds during school hours, generating and transmitting an alert to at least one of the school administrators to be displayed on a respective one of the administrator electronic devices.

22. The system of claim 21, wherein the application program, when executed by a processor, causes the non-transitory computer-readable recording medium to additionally transmit the alert to an electronic device of a parent or guardian of a respective one of the students.

23. The system of claim 21, wherein the application program, when executed by a processor, causes the non-transitory computer-readable recording medium to additionally store a list of the students whose actions generated the alert and generate a list of the students to be displayed on a respective one of the administrator electronic devices for review by at least one of the school administrators.

24. The system of claim 21, wherein the application program, when executed by a processor, causes the non-transitory computer-readable recording medium to allow at least one of the school administrators to customize the list of the social media applications not permitted to be accessed, the school location, and the school hours for each of the students and assign such customization to the student user credential for each of the students.

25. The system of claim 22, wherein the application program, when executed by a processor, causes the non-transitory computer-readable recording medium to additionally store a list of the students whose actions generated the alert and generate a list of the students to be displayed on a respective one of the administrator electronic devices for review by at least one of the school administrators.

26. The system of claim 25, wherein the application program, when executed by a processor, causes the non-transitory computer-readable recording medium to allow at least one of the school administrators to customize the list of the social media applications not permitted to be accessed, the school location, and the school hours for each of the students and assign such customization to the student user credential for each of the students.

27. A computer-implemented method of monitoring and managing the access of a student to social media applications in a school comprising the steps of:
storing a list of social media applications not permitted to be accessed by students on student mobile phones at a school location during school hours upon the student mobile phones being in operable connection with a school computer network;
storing a list of the students registered to use the application program on the application server;
assigning a student user credential to each of the students that are registered to use the application program;
storing a list of school administrators registered to use the application program on the application server;
assigning an administrator user credential to each of the school administrators that are registered to use the application program;
blocking access to only the social media applications on the student mobile phones when the student mobile phones are in operable connection with the school computer network on school grounds during school hours without affecting other functions of the student mobile phones including calling, texting, web browsing, and accessing email;
monitoring and temporarily storing the activity of the students on the student mobile phones when the student mobile phones are in operable connection with the school computer network on school grounds during school hours; and
periodically reviewing the activity and, upon detecting an attempt by at least one of the students to access at least one of the social medial applications or a web page hosting a social media account when the student mobile phones are in operable connection with the school computer network on school grounds during school hours, generating and transmitting an alert to at least one of the school administrators to be displayed on a respective one of a plurality of administrator electronic devices.

28. The method of claim 27, further comprising additionally transmitting the alert to an electronic device of a parent or guardian of a respective one of the students.

29. The method of claim 27, further comprising storing a list of the students whose actions generated the alert and generate a list of the students to be displayed on a respective one of the administrator electronic devices for review by at least one of the school administrators.

30. The method of claim 27, further comprising customizing the list of the social media applications not permitted to be accessed, the school location, and the school hours for each of the students and assigning such customization to the student user credential for each of the students.

31. The method of claim 28, further comprising storing a list of the students whose actions generated the alert and generate a list of the students to be displayed on a respective one of the administrator electronic devices for review by at least one of the school administrators.

32. The method of claim 31, further comprising customizing the list of the social media applications not permitted to be accessed, the school location, and the school hours for each of the students and assigning such customization to the student user credential for each of the students.
